(19) United States
(12) Patent Application Publication
(10) Pub. No.: US 2014/0270429 A1
(43) Pub. Date: Sep. 18, 2014

(54) Parallelized Tree-Based Pattern Recognition for Tissue Characterization

(71) Applicant: Volcano Corporation, San Diego, CA (US)

(72) Inventors: Anuja Nair, Bedford, MA (US); Russell J. Fedewa, Shaker Heights, OH (US); Miklos Z. Kiss, Sykesville, MD (US)

(73) Assignee: Volcano Corporation, San Diego, CA (US)

(21) Appl. No.: 14/209,915

(22) Filed: Mar. 13, 2014

Related U.S. Application Data
(60) Provisional application No. 61/785,589, filed on Mar. 14, 2013.

(51) Int. Cl. G06T 7/00

(52) U.S. Cl. CPC G06T 7/0012
USPC 382/128

(57) ABSTRACT

Systems and methods for tissue characterization using multiple independent pattern recognition models are provided. Some embodiments are particularly directed to analyzing medical imaging data. In one embodiment, a method includes receiving a set of medical imaging data and receiving a set of independent tissue characterization models. Each of the set of independent tissue characterization models is applied to the set of medical imaging data in order to obtain a plurality of interim classification results. An arbitration of the plurality of interim classification results is performed to determine a constituent tissue for the set of medical imaging data. The determined constituent tissue may be displayed in combination with a graphical representation of the set of medical imaging data. Each of the set of independent tissue characterization models may be applied to the set of medical imaging data in parallel.

### CROSS-REFERENCE TO RELATED APPLICATIONS

The present application claims priority to and the benefit of U.S. Provisional Patent Application No. 61/785,589, filed Mar. 14, 2013, which is hereby incorporated by reference in its entirety.

### TECHNICAL FIELD

The present disclosure relates generally to the field of medical sensing and, more particularly, to systems and methods for analyzing medical imaging data and characterizing imaged tissues for use in diagnosing and treating disease.

### BACKGROUND

Innovations in diagnosing and verifying the level of success of treatment of disease have migrated from external imaging processes to internal diagnostic processes. In particular, diagnostic equipment and processes have been developed for diagnosing vasculature blockages and other vasculature disease by means of ultra-miniature sensors placed upon the distal end of a flexible elongate member such as a catheter or a guide wire used for catheterization procedures. For example, known medical sensing techniques include angiography, intravascular ultrasound (IVUS), forward looking IVUS (FL-IVUS), fractional flow reserve (FFR) determination, a coronary flow reserve (CFR) determination, optical coherence tomography (OCT), trans-esophageal echocardiography, and image-guided therapy. Each of these techniques may be better suited for different diagnostic situations. To increase the chance of successful treatment, health care facilities may have a multitude of imaging, treatment, diagnostic, and sensing modalities on hand during a procedure.

Pattern recognition in medical imaging identifies biological and inorganic structures based on characteristic signatures and highlights them for viewing, thus providing operators with a better depiction of an imaged area. Methods and systems for recognizing tissues and tissue types have been used in both diagnostic and therapeutic applications. For example, U.S. Pat. No. 6,200,268 entitled “VASCULAR PLAQUE CHARACTERIZATION;” U.S. Pat. No. 6,381,350 entitled “INTRAVASCULAR ULTRASONIC ANALYSIS USING ACTIVE CONTOUR METHOD AND SYSTEM;” U.S. Pat. No. 7,074,188 entitled “SYSTEM AND METHOD OF CHARACTERIZING VASCULAR TISSUE;” U.S. Pat. No. 7,175,597 entitled “NON-INVASIVE TISSUE CHARACTERIZATION SYSTEM AND METHOD;” U.S. Pat. No. 7,215,802 entitled “SYSTEM AND METHOD FOR VASCULAR BORDER DETECTION;” U.S. Pat. No. 7,359,554 entitled “SYSTEM AND METHOD FOR IDENTIFYING A VASCULAR BORDER;” U.S. Pat. No. 7,627,156 entitled “AUTOMATED LESION ANALYSIS BASED UPON AUTOMATIC PLAQUE CHARACTERIZATION ACCORDING TO A CLASSIFICATION CRITERION;” and U.S. Pat. No. 7,988,633 entitled “APPARATUS AND METHOD FOR USE OF RFID CATHETER INTELLIGENCE” disclose pattern recognition in greater detail and are hereby incorporated by reference in their entirety.

While these methods and systems for recognizing tissues and tissue types have proved generally adequate, advances in imaging and in therapeutic applications have made pattern recognition increasingly central to patient care. Therefore, accuracy and speed are of paramount importance. For these reasons and others, further advances in tissue pattern recognition have the potential to measurably improve patient outcomes.

### SUMMARY

Embodiments of the present disclosure provide an enhanced system and method for tissue characterization using multiple independent characterization models.

In some embodiments, a method for analyzing medical imaging data is provided. The method includes receiving a set of medical imaging data and receiving a set of independent tissue characterization models. Each of the set of independent tissue characterization models is applied to the set of medical imaging data in order to obtain a plurality of interim classification results. An arbitration of the plurality of interim classification results is performed to determine a constituent tissue for the set of medical imaging data. In one such embodiment, each of the set of independent tissue characterization models is applied to the set of medical imaging data in parallel. In another such embodiment, each of the set of independent tissue characterization models is applied to the set of medical imaging data concurrently. In a further such embodiment, the method further includes displaying the determined constituent tissue in combination with a graphical representation of the set of medical imaging data.

In some embodiments, a medical data processing system is provided. The system includes a sensor I/O interface operable to receive imaging data from an imaging instrument, and a plurality of classification cores each operable to receive an independent characterization model and to apply the respective independent characterization model to the received imaging data to produce an interim tissue identification. The system further includes a weighing module operable to receive the interim tissue identification from each of the plurality of classification cores and to determine a constituent tissue from the interim tissue identifications based on an arbitration scheme. In one such embodiment, the received independent characterization models each include a classification tree, and each of the plurality of classification cores are further operable to traverse the respective classification tree to produce the interim tissue identification. In a further such embodiment, the weighing module is further operable to apply a voting scheme to the interim tissue identifications to determine the constituent tissue. In yet a further such embodiment, the voting scheme weighs votes based on a certainty associated with each of the interim tissue identifications.

In some embodiments, a method for constructing a tissue characterization model is provided. The method includes receiving imaging data samples and correlating the imaging data samples to observed corresponding histology to determine a constituent tissue for each of the imaging data samples. The imaging data samples are grouped into a plurality of groups. A tissue characterization sub-model is constructed for each group of the plurality of groups based on imaging data samples grouped into the respective group. Each of the tissue characterization sub-models is independently operable to characterize an unknown imaging data sample. In one such embodiment, each of the sub-models includes a classification tree. In a further such embodiment, the grouping of the imaging data samples utilizes a random grouping scheme.

The systems and methods of the present disclosure perform pattern recognition on medical sensing data and may thereby identify tissues, tissue categories, inorganic materials, and/or other suitable organic and inorganic structures. In some embodiments, multiple independent models or sub-models are used to identify the tissues. Because the models are based on a reduced set of reference samples compared to a single monolithic model, each model may be simpler with fewer branches and greater certainty (though not necessarily greater individual accuracy) than the monolithic model. Simplicity improves recognition speed and reduces the need for pruning, which may compromise prediction accuracy. Due to the independent nature of each model, in some embodiments, the models may be applied independently as separate threads on a multithreaded or multi-core processor. This may further improve recognition speed. As a further advantage, in some embodiments, multiple parallel models reduce the effects of statistical outliers in the reference set of data used to construct the trees. Of course, it is understood that these advantages are merely exemplary, and no particular advantage is required for any particular embodiment.

Additional aspects, features, and advantages of the present disclosure will become apparent from the following detailed description.

### BRIEF DESCRIPTION OF THE DRAWINGS

Illustrative embodiments of the present disclosure will be described with reference to the accompanying drawings, of which:

FIG. 1 is a schematic drawing of a medical system including a medical sensing data processing system according to some embodiments of the present disclosure.

FIG. 2 is a schematic drawing of a medical sensing system according to some embodiments of the present disclosure.

FIG. 3 is a graphic representation of an exemplary signal collected by a medical sensing system according to some embodiments of the present disclosure.

FIG. 4 is a diagram of an exemplary display of a set of imaging signals according to some embodiments of the present disclosure.

FIG. 5 is a flow diagram of a method for building a tissue characterization model according to some embodiments of the present disclosure.

FIG. 6 is a diagram of an exemplary classification tree for tissue pattern recognition according to some embodiments of the present disclosure.

FIG. 7 is a graphic illustration of an imaging dataset having undergone a method for building a tissue characterization model according to some embodiments of the present disclosure.

FIG. 8 is a flow diagram of a method of building a tissue characterization model incorporating multiple parallel sub-models according to some embodiments of the present disclosure.

FIG. 9 is a functional block diagram of portions of the data processing systems of FIGS. 1 and 2, including a pattern recognition engine, according to some embodiments of the present disclosure.

FIG. 10 is a flow diagram of a method for tissue characterization suitable for execution using a pattern recognition engine according to some embodiments of the present disclosure.

FIG. 11 is a diagram of an exemplary user interface for displaying characterized tissue according to some embodiments of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

FIG. 1 is a schematic drawing depicting a medical system 100 including a medical sensing data processing system 101 according to some embodiments of the present disclosure. In general, the medical system 100 provides for coherent integration and consolidation of multiple forms of acquisition and processing elements designed to be sensitive to a variety of methods used to acquire and interpret human biological physiology and morphological information and coordinate treatment of various conditions. More specifically, in system 100, the medical sensing data processing system 101 is an integrated device for the acquisition, control, interpretation, and display of medical sensing data. In one embodiment, the processing system 101 is a computer system with the hardware and software to acquire, process, and display multi-modality medical data, but, in other embodiments, the processing system 101 may be any other type of computing system operable to process medical data. In the embodiments in which processing system 101 is a computer workstation, the system includes at least a processor such as a microcontroller or a dedicated central processing unit (CPU), a non-transitory computer-readable storage medium such as a hard drive, random access memory (RAM), and/or compact disk read only memory (CD-ROM), a video controller such as a graphics processing unit (GPU), and a network communication device such as an Ethernet controller or wireless communication controller. In that regard, in some particular instances the processing system 101 is programmed to execute steps associated with the data acquisition and analysis described herein. Accordingly, it is understood that any steps related to data acquisition, data processing, instrument control, and/or other processing or control aspects of the present disclosure may be implemented by the processing system using corresponding instructions stored on or in a non-transitory computer readable medium accessible by the processing system. In some instances, the processing system 101 is portable (e.g., handheld, on a rolling cart, etc.). Further, it is understood that in some instances processing system 101 comprises a plurality of computing devices. In that regard, it is particularly understood that the different processing and/or control aspects of the present disclosure may be implemented separately or within predefined groupings using a plurality of computing devices. Any divisions and/or combinations of the processing and/or control aspects described below across multiple computing devices are within the scope of the present disclosure.

In the illustrated embodiment, the medical system 100 is deployed in a catheter lab 102 having a control room 104, with the processing system 101 being located in the control room. In other embodiments, the processing system 101 may be located elsewhere, such as in the catheter lab 102, in a centralized area in a medical facility, or at an off-site location (i.e., in the cloud). The catheter lab 102 includes a sterile field generally encompassing a procedure area but its associated control room 104 may or may not be sterile depending on the requirements of a procedure and/or health care facility. The catheter lab and control room may be used to perform on a patient any number of medical sensing procedures such as angiography, intravascular ultrasound (IVUS), virtual histology (VH), forward looking IVUS (FL-IVUS), intravascular photoacoustic (IVPA) imaging, a fractional flow reserve (FFR) determination, a coronary flow reserve (CFR) determination, optical coherence tomography (OCT), computed tomography, intracardiac echocardiography (ICE), forward-looking ICE (FLICE), intravascular palpography, transesophageal ultrasound, or any other medical sensing modality known in the art. Further, the catheter lab and control room may be used to perform one or more treatment or therapy procedures on a patient such as radiofrequency ablation (RFA), cryotherapy, atherectomy or any other medical treatment procedure known in the art. For example, in the catheter lab 102, a patient 106 may be undergoing a multi-modality procedure either as a single procedure or in combination with one or more sensing procedures. In any case, the catheter lab 102 includes a plurality of medical instruments including medical sensing devices that may collect medical sensing data in various different medical sensing modalities from the patient 106.

In the illustrated embodiment of FIG. 1, instruments 108 and 110 are medical sensing devices that may be utilized by a clinician to acquire medical sensing data about the patient 106. In a particular instance, the instrument 108 collects medical sensing data in one modality and the instrument 110 collects medical sensing data in a different modality. For instance, the instruments may each collect one of pressure, flow (velocity), images (including images obtained using ultrasound (e.g., IVUS), OCT, thermal, and/or other imaging techniques), temperature, and/or combinations thereof. The devices 108 and 110 may be any form of device, instrument, or probe sized and shaped to be positioned within a vessel, attached to an exterior of the patient, or scanned across a patient at a distance.

In the illustrated embodiment of FIG. 1, instrument 108 is an IVUS catheter 108 that may include one or more sensors such as a phased-array transducer to collect IVUS sensing data. In some embodiments, the IVUS catheter 108 may be capable of multi-modality sensing such as IVUS and IVPA sensing. Further, in the illustrated embodiment, the instrument 110 is an OCT catheter 110 that may include one or more optical sensors configured to collect OCT sensing data. In some instances, an IVUS patient interface module (PIM) 112 and an OCT PIM 114 respectively couple the IVUS catheter 108 and OCT catheter 110 to the medical system 100. In particular, the IVUS PIM 112 and the OCT PIM 114 are operable to respectively receive medical sensing data collected from the patient 106 by the IVUS catheter 108 and OCT catheter 110 and are operable to transmit the received data to the processing system 101 in the control room 104. In one embodiment, the PIMs 112 and 114 include analog to digital (A/D) converters and transmit digital data to the processing system 101. However, in other embodiments, the PIMs transmit analog data to the processing system. In one embodiment, the IVUS PIM 112 and OCT PIM 114 transmit the medical sensing data over a Peripheral Component Interconnect Express (PCIe) data bus connection, but, in other embodiments, they transmit data over a USB connection, a Thunderbolt connection, a FireWire connection, or some other high-speed data bus connection. In other instances, the PIMs may be connected to the processing system 101 via wireless connections using IEEE 802.11 Wi-Fi standards, Ultra Wide-Band (UWB) standards, wireless FireWire, wireless USB, or another high-speed wireless networking standard.

Additionally, in the medical system 100, an electrocardiogram (ECG) device 116 is operable to transmit electrocardiogram signals or other hemodynamic data from patient 106 to the processing system 101. In some embodiments, the processing system 101 may be operable to synchronize data collected with the catheters 108 and 110 using ECG signals from the ECG 116. Further, an angiogram system 117 is operable to collect x-ray, computed tomography (CT), or magnetic resonance images (MRI) of the patient 106 and transmit them to the processing system 101. In one embodiment, the angiogram system 117 may be communicatively coupled to the processing system to the processing system 101 through an adapter device. Such an adaptor device may transform data from a proprietary third-party format into a format usable by the processing system 101. In some embodiments, the processing system 101 may be operable to co-register image data from angiogram system 117 (e.g., x-ray data, MRI data, CT data, etc.) with sensing data from the IVUS and OCT catheters 108 and 110. As one aspect of this, the co-registration may be performed to generate three-dimensional images with the sensing data.

A bedside controller 118 is also communicatively coupled to the processing system 101 and provides user control of the particular medical modality (or modalities) being used to diagnose the patient 106. In the current embodiment, the bedside controller 118 is a touch screen controller that provides user controls and diagnostic images on a single surface. In alternative embodiments, however, the bedside controller 118 may include both a non-interactive display and separate controls such as physical buttons and/or a joystick. In the integrated medical system 100, the bedside controller 118 is operable to present workflow control options and patient image data in graphical user interfaces (GUIs). The bedside controller 118 includes a user interface (UI) framework service through which workflows associated with respective modalities may execute. Thus, the bedside controller 118 is capable displaying workflows and diagnostic images for one or more modalities allowing a clinician to control the acquisition of medical sensing data with a single interface device.

A main controller 120 in the control room 104 is also communicatively coupled to the processing system 101 and, as shown in FIG. 1, is adjacent to catheter lab 102. In the current embodiment, the main controller 120 is similar to the bedside controller 118 in that it includes a touch screen and is operable to display multitude of GUI-based workflows corresponding to different medical sensing modalities via a UI framework service executing thereon. In some embodiments, the main controller 120 may be used to simultaneously carry out a different aspect of a procedure's workflow than the bedside controller 118. In alternative embodiments, the main controller 120 may include a non-interactive display and standalone controls such as a mouse and keyboard.

The medical system 100 further includes a boom display 122 communicatively coupled to the processing system 101. The boom display 122 may include an array of monitors, each capable of displaying different information associated with a medical sensing procedure. For example, during an IVUS procedure, one monitor in the boom display 122 may display a tomographic view and one monitor may display a sagittal view.

Further, the medical sensing data processing system 101 is communicatively coupled to a data network 125. In the illustrated embodiment, the data network 125 is a TCP/IP-based local area network (LAN); however, in other embodiments, it may utilize a different protocol such as Synchronous Optical Networking (SONET), or may be a wide area network (WAN). The processing system 101 may connect to various resources via the network 125. For example, the processing system 101 may communicate with a Digital Imaging and Communications in Medicine (DICOM) system 126, a Picture Archiving and Communication System (PACS) 127, and a Hospital Information System (HIS) 128 through the network 125. Additionally, in some embodiments, a network console 130 may communicate with the medical sensing data processing system 101 via the network 125 to allow a doctor or other health professional to access the aspects of the medical system 100 remotely. For instance, a user of the network console 130 may access patient medical data such as diagnostic images collected by medical sensing data processing system 101, or, in some embodiments, may monitor or control one or more on-going procedures in the catheter lab 102 in real-time. The network console 130 may be any sort of computing device with a network connection such as a PC, laptop, smartphone, tablet computer, or other such device located inside or outside of a health care facility.

Additionally, in the illustrated embodiment, medical sensing tools in system 100 discussed above are shown as communicatively coupled to the processing system 101 via a wired connection such as a standard copper link or a fiber optic link, but, in alternative embodiments, the tools may be connected to the processing system 101 via wireless connections using IEEE 802.11 Wi-Fi standards, Ultra Wide-Band (UWB) standards, wireless FireWire, wireless USB, or another high-speed wireless networking standard.

One of ordinary skill in the art would recognize that the medical system 100 described above is simply an example embodiment of a system that is operable to collect diagnostic data associated with one or more of medical modalities. In alternative embodiments, different and/or additional tools may be communicatively coupled to the processing system 101 so as to contribute additional and/or different functionality to the medical system 100.

In many embodiments, the medical system 100 obtains sensing data that contains information about the environment surrounding the sensing instrument, such as IVUS signal data or OCT signal data. In some such embodiments, the medical system 100 is operable to perform a tissue characterization technique on the sensing data to identify the tissues and materials of the surrounding environment. The recognized structures are displayed to the operator using color overlays, pseudo-topographic outlines, markers, and other indicators.

Referring now to FIG. 2, illustrated is a diagrammatic schematic view of a medical sensing system 200 according to some embodiments of the present disclosure. The medical sensing system 200 is suitable for use as a standalone system or as part of a larger medical imaging system including the medical system 100 of FIG. 1. In that regard, elements of the sensing system 200 may be incorporated into elements of medical system 100. In alternate embodiments, elements of the sensing system 200 are distinct from and are in communication with elements of the medical system 100.

The medical sensing system 200 includes an elongate member 202. As used herein, “elongate member” or “flexible elongate member” includes at least any thin, long, flexible structure that can be inserted into the vasculature of a patient. While the illustrated embodiments of the “elongate members” of the present disclosure have a cylindrical profile with a circular cross-sectional profile that defines an outer diameter of the flexible elongate member, in other instances all or a portion of the flexible elongate members may have other geometric cross-sectional profiles (e.g., oval, rectangular, square, elliptical, etc.) or non-geometric cross-sectional profiles. Flexible elongate members include, for example, guide wires, catheters, and guide catheters. In that regard, a catheter may or may not include a lumen extending along its length for receiving and/or guiding other instruments. If the catheter includes a lumen, the lumen may be centered or offset with respect to the cross-sectional profile of the device.

Elongate member 202 includes sensors 204 disposed along the length of the member 202. In some embodiments, the elongate member 202 includes one or more sensors (e.g., sensor 204) disposed at the distal end 206. In various embodiments, the sensors 204 correspond to sensing modalities such as flow, optical flow, IVUS, photoacoustic IVUS, FL-IVUS, pressure, optical pressure, fractional flow reserve (FFR) determination, coronary flow reserve (CFR) determination, OCT, transesophageal echocardiography, image-guided therapy, other suitable modalities, and/or combinations thereof. In an exemplary embodiment, sensor 204 is an IVUS ultrasound transceiver. In another embodiment, sensor 204 is an OCT transceiver. Other embodiments incorporate other combinations of sensors, and no particular sensor or combination of sensors is required for any particular embodiment.

The electronic, optical, and/or electro-optical sensors 204, components, and associated communication lines 208 are sized and shaped to allow for the diameter of the flexible elongate member 202 to be very small. For example, the outside diameter of the elongate member 202, such as a guide wire or catheter, containing one or more electronic, optical, and/or electro-optical components as described herein is between about 0.0007″ (0.0178 mm) and about 0.118″ (3.0 mm), with some particular embodiments having outer diameters of approximately 0.014″ (0.3556 mm), approximately 0.018″ (0.4572 mm), and approximately 0.035″ (0.889 mm)). As such, the flexible elongate members 202 incorporating the electronic, optical, and/or electro-optical component(s) of the present application are suitable for use in a wide variety of lumens within a human patient besides those that are part or immediately surround the heart, including veins and arteries of the extremities, aorta, renal arteries, blood vessels in and around the brain, and other lumens.

The distal end 206 of the elongate member 202 is advanced through a vessel 210 (or vascular structure). Vessel 210 represents fluid filled or surrounded structures, both natural and man-made, within a living body and can include for example, but without limitation, structures such as: organs including the liver, heart, kidneys, gall bladder, pancreas, lungs; ducts; intestines; nervous system structures including the brain, dural sac, spinal cord and peripheral nerves; the urinary tract; the pulmonary tree; as well as valves within the blood or other systems of the body. In addition to natural structures, elongate member 202 may be used to examine man-made structures such as, but without limitation, heart valves, stents, shunts, filters and other devices positioned within the body, for example, a guide wire or guide catheter.

When the sensor 204 is active, a communications channel 208, such as an optical fiber, a conductor bundle, and/or a wireless transceiver, present in the elongate member 202 carries sensor data to a patient interface monitor (PIM) 212 coupled to the proximal end 214 of the elongate member 202. The PIM 212 may be substantially similar to the IVUS PIM 112 and/or OCT PIM 114 disclosed with reference to FIG. 1. For example, the PIM 212 is operable to receive medical sensing data collected using the sensors and is operable to transmit the received data to a processing system 101 substantially similar to the medical data processing system 101 of FIG. 1. In some embodiments, the PIM 212 performs preliminary processing of the sensing data prior to transmitting the data to the processing system 101. In examples of such embodiments, the PIM 212 performs amplification, filtering, time-stamping, identification, and/or aggregating of the data. The PIM 212 also transfers data such as commands from the processing system 101 to the sensors of the elongate member 202. In an exemplary embodiment, these commands include commands to enable and disable sensors and/or to configure modes of operation for individual sensors. In some embodiments, the PIM 212 also supplies power to drive the operation of the sensor(s) 204.

The PIM 212 is communicatively coupled to the processing system 101, which governs sensor operation and data acquisition, processing, interpretation, and display. In many respects, the processing system 101 is substantially similar to the imaging system 101 of FIG. 1. In that regard, the processing system 101 receives sensor data from the sensors of the elongate member 202 via the PIM 212, processes the sensor data to render it suitable for display, and presents the processed sensor data at a user display 216 such as one of the displays incorporated to the bedside controller 118, main controller 120, or boom display 122 disclosed with reference to FIG. 1.

In an illustrative example of a typical environment and application of the system 200, a surgeon advances a guide wire 218 through a vascular structure 210 to a region of the vascular structure 210 to be imaged. The guide wire 218 is threaded through at least a portion of the distal end 206 of the elongate member 202 so that the elongate member 202 can be advanced over the guide wire 218 and through the vascular structure 210. Once the sensor 204 has reached the region to be imaged, the sensor 204 is activated. Depending on the modality, the sensor 204 may produce an emission such as an ultrasonic waveform in the case of some IVUS sensors 204 or a near-infrared light emission in the case of some OCT sensors 204. Other emissions may include X-ray and/or other penetrating radiation. The emitted waveform is reflected by the vascular structure 210, and the reflected echoes are received by one or more receiving sensors, which, in some embodiments, may include the emitting sensor 204. The received echo signals are transmitted to the PIM 212 via a communications channel 208 such as a conductive or fiber-optic conduit or a wireless communications interface. The PIM 212 may amplify the echo data and may perform preliminary pre-processing before transmitting the echo data to the data processing system 101. The data processing system 101, in turn, further processes, aggregates, and assembles the received echo data to create an image of the vascular structure 210 for display on the display 216. In some exemplary applications, the elongate member 202 is advanced beyond the area of the vascular structure 210 to be imaged and pulled back as the sensor 204 is operating, thereby exposing and imaging a longitudinal portion of the vascular structure 210. To ensure a constant speed, a pullback mechanism is used in some instances. A typical withdraw speed is 0.5 mm/s.

As illustrated in FIG. 2, in many embodiments, the sensor 204 is focused in a direction 220 extending radially outward from the elongate member 202. Thus, the sensor 204 collects data in a scan line extending radially outward from the elongate member 202. In order to obtain a more comprehensive view, a set of radial scan lines may be collected and assembled by the data processing system 101. This disclosure encompasses embodiments using a mechanically rotated or oscillated sensor 204, a circumferentially-arranged array of sensors 204, an omnidirectional sensor 204, as well as other suitable sensor configurations operable to collect the set of scan lines. Thus, in some embodiments, the sensor 204 is a single, mechanically-rotated IVUS or OCT device. In other embodiments, the distal end 206 of the elongate member 202 includes an array of sensors 204 circumferentially positioned to cover 360°, where each transducer is configured to radially acquire data from a fixed position on the catheter.

Referring now to FIG. 3, an exemplary signal 300 collected by a medical sensing system is illustrated according to some embodiments of the present disclosure. The exemplary signal 300 is characteristic of a received ultrasound echo signal. However, in further embodiments, signal 300 corresponds to a reflected ultrasound emission, a reflected light emission, an X-ray emission, and/or other suitable imaging signal. The signal 300 is a measure of signal strength or intensity (plotted along a y-axis 302) versus time (plotted along an x-axis 304). Signal intensity is correlated to the reflectivity of a point scatterer located in the imaging field, and time roughly correlates to the point scatterer's location. Signal intensity, frequency effects, and other properties of the signal 300 may be used to determine the makeup of the point scatterers represented by the scan line, with the signal information serving as a signature for a particular material, tissue, tissue type, etc.

A set of exemplary signals 300 representing 360° of acquisition may be obtained and assembled for display. This may include converting signal characteristics to luminance (brightness) or chromatic (color) values, and arranging the signals according to the spatial orientation of the corresponding scan line. Referring now to FIG. 4, illustrated is an exemplary display 400 of a set of imaging signals according to some embodiments of the present disclosure. The signals of the set may correspond to any number of scan lines, with an exemplary set including 256 scan lines. For reference, scan lines 402, 404, and 406 are illustrated with dashed lines.

A sensing data processing system 101 constructs the displayed image 400 from the imaging signals in order to visually represent the surrounding vessel 210. This process may include steps to remove noise and reduce distortion, steps to determine precise location from time-of-flight, steps to enhance resolution, steps to convert linear data to a polar representation, and other processing steps recognized to one of skill in the art. The resulting display 400 is a radial cross-section (and/or conical view for forward-looking embodiments) of the vessel 210. The central circular portion 408 of the display 400, which does not contain any processed signal, corresponds to the cross section of the elongate member 202.

As mentioned above, different vascular components (comprising different types and densities of tissues and cells) and boundaries between tissues, absorb and reflect imaging signals differently. For example, in an embodiment, an IVUS sensor 204 emits an ultrasound waveform at about 45 MHz, which is reflected by tissues that comprise a vessel 210. However, in the example, the reflected ultrasound echo includes a host of different frequencies produced by the resonance characteristics of the tissues within the bandwidth of the 45 MHz IVUS transducer. These resonance characteristics and the corresponding echo signal effects can be used to determine the morphology of the imaged environment based on signal pattern recognition techniques. Thus, the processing system 101 may identify tissues (e.g., thrombus, plaque, adventitia, fibrous tissue, fibro-lipidic tissue, calcified necrotic tissue, calcific tissue, cholesterol, vessel wall, etc.), fluids, tissue categories (e.g., plaques may be further characterized as one of fibrous, fibro-fatty, necrotic core, or dense calcium), inorganic materials (e.g., stents, surgical instruments, radiographic and/or echographic markers, etc.), and/or other suitable organic and inorganic structures (e.g., tissue borders, lumens, etc). For conciseness, these tissues, tissue types, organic and inorganic materials, and/or other suitable structures will be referred to as “constituent tissues.” After having identified the constituent patterns and/or tissues from the received imaging data, the processing system 101 may present the identified structures, including borders or boundaries between different regions, to the operator. To understand suitable methods for performing tissue characterization, it may be useful to first disclose how a pattern recognition model is constructed.

Referring now to FIG. 5, a method 500 is disclosed for building a tissue characterization model according to some embodiments of the present disclosure. It is understood that additional steps can be provided before, during, and after the method 500 and that some of the steps described can be replaced or eliminated for other embodiments of the method 500. The method 500 obtains imaging data for one or more constituent tissues from prepared specimens and correlates parameters of the imaging data to the constituent tissues. A model is then built to distinguish the characteristic signatures of each tissue. The model can then be applied during a surgical procedure to identify unknown tissues based on their imaging characteristics.

Referring to block 502, vascular specimens are obtained. These specimens are typically procured from human donors. However, animal specimens and manufactured models may be acceptable in some embodiments. The specimens, whether human, animal, or artificial, may be screened for suitability. In one example, specimens were limited to human donors without prior cardiac percutaneous interventions or surgical revascularization and with no history of alcohol or drug abuse and no known blood-born pathogen diseases.

Referring to block 504, the specimens are imaged using an imaging system substantially similar to systems 100 and 200 disclosed with reference to FIGS. 1 and 2, respectively. As the resulting tissue signatures may be device specific, the imaging system used to image the vascular specimens may be representative of the imaging system that will be used in the field. To perform the imaging, in an exemplary embodiment, a vascular specimen is perfused using a phosphate-buffered saline (PBS) solution and submerged within PBS to minimize air-fluid interface reflections. The perfusion simulates the vascular specimen in its natural, in vivo condition. A reference marker such as a suture may be added to the vascular specimen to mark orientation and/or regions of interest. The elongate member 202 of the imaging system 200 is then advanced into the perfused vessel, and the vessel is imaged. The imaging of block 504 obtains a set of imaging data for each of the vascular specimens.

Referring to block 506, the specimens are prepared for histological inspection. In an embodiment, a specimen is pressure fixed using 10% buffered formalin at systolic pressure for at least four hours. The vessel is then sectioned and paraffin embedded. Preparation may also include a histological staining using indicators such as hematoxylin and eosin (H&E) and/or Movat pentachrome stains, among others.

Referring to block 508, a histology review is performed on the prepared specimens by a histology expert. The review determines the constituent tissues of the vascular specimen and cross-references tissues against their location and orientation within the vessel. The review may also cross-reference tissues against their position relative to other structures (e.g., side branches, other veins, myocardium, pericardium, etc.). The review may focus on any relevant constituent tissues including tissues, tissue categories, inorganic materials, and/or other suitable organic and inorganic structures.

Referring to block 510, the observed histology is spatially correlated to the imaging data by the imaging system. The comparison identifies the portions of the imaging data set that correspond to the identified constituent tissues.

Referring to block 512, the imaging data set is examined for parameters with the potential to be used as selection criteria for distinguishing constituent tissues. These parameters may come from the imaging data itself. In the example of an IVUS imaging data set, temporal (e.g., time in sample, root-mean-square, etc.) and/or spectral parameters (e.g., center frequency, integrated backscatter, mid-band fit, intercept, slope, maximum power, frequency at maximum power, minimum power, and frequency at minimum power) derived from 1-dimensional, 2-dimensional, or multi-dimensional data may be considered as well as range (distance between the tissue and the sensor). The parameters may also include related factors such as patient demographics, medical history, coexisting conditions, and/or other suitable parameters. Parameters may be considered based on selectivity, discrimination, and other factors. In some embodiments, parameters are included or excluded based on known predictive value. For example, parameters known to be useful in characterizing 20 MHz IVUS imaging data may be considered for characterizing 45 MHz IVUS imaging data. In some embodiments, parameters are included or excluded based on whether they can be determined rapidly during the course of a surgical procedure. Parameters that may delay display of imaging data or pattern recognition results may be excluded in some embodiments.

Referring to block 514, the imaging data is divided into discrete data points, or samples, each corresponding to a constituent tissue. Each sample represents a known occurrence of a particular constituent tissue and the corresponding imaging data. A set of samples may be identified for each constituent tissue.

Referring to block 516, a model is constructed for distinguishing the constituent tissues based on the sets of samples. Numerous methods of distinguishing constituent tissues and for constructing predictive models for performing characterization are known in the art. For example, U.S. Patent Publication No. 2013/00044924, entitled “CLASSIFICATION TREES ON GPGPU COMPUTE ENGINES,” discloses optimizing classification tree evaluation for characterization of tissue, and is hereby incorporated by reference in its entirety. In brief, classification trees are predictive models used to systematically evaluate an unknown sample against a set of selection criteria to determine a match. A tree may be expressed as a hierarchical set of nodes linked by branches. Nodes with further branches are decision nodes and represent one or more comparison steps, whereas terminal nodes, or leaf nodes, represent conclusions of the classification process.

FIG. 6 is a diagram of an exemplary classification tree 600 for tissue pattern recognition according to some embodiments of the present disclosure. The classification tree 600 is structured to compare unknown or uncharacterized imaging data, such as a portion of exemplary signal 300 disclosed with reference to FIG. 3, against tissue-related image and signal signatures in order to determine the constituent tissues. Accordingly, the leaf nodes (e.g., leaf nodes 610-622) represent matches to a constituent tissue. The decision nodes (e.g., decision nodes 602-608) represent comparisons using parameters, or selection criteria, of the imaging data. In some embodiments, each decision node represents a comparison to a single parameter associated with the modality of the imaging data. For example, in an embodiment performing pattern recognition on IVUS backscattered data, decision node 602 corresponds to a center-frequency parameter, decision node 604 corresponds to an integrated-backscatter parameter, and decision node 606 corresponds to a root-mean-square (RMS) parameter. In further embodiments, each decision node represents a comparison using a combination (e.g., a linear or Boolean combination) of signal parameters. Parameters may also be repeated at multiple decision nodes as needed. Based on the results of the comparison of the decision node, a branch is selected, and branches may represent binary values, contiguous or discontiguous ranges, and other suitable divisions. In some embodiments, a branch is designated as a default. Based upon the comparison, the selected branch is then traced to the next decision or leaf node.

A medical sensing data processing system 101 (such as the data processing system 101 of FIGS. 1 and 2) utilizing the classification tree 600 to perform pattern recognition begins at a starting decision node or root node (e.g., node 602) and performs the corresponding comparison using the parameters specified by the root node. Based on the results, the system follows the appropriate branch to a subsequent decision node or leaf node. The process continues until a leaf node is reached, at which point the corresponding constituent tissue has been identified.

As can be seen from the embodiment of FIG. 6, the result of the pattern recognition (i.e., the terminal leaf node and corresponding tissue) depends, in part, on the branch criteria. This includes both the parameters selected for use in the determination and the breakpoint values, particularly if the branch criterion is a range. FIG. 7 illustrates one set of challenges associated with constructing an accurate classification tree. FIG. 7 is a graphic illustration of an imaging dataset 700 having undergone a method for building a tissue characterization model according to some embodiments of the present disclosure. The dataset 700 and elements of FIG. 7 have been simplified in the interest of clarity.

For each of the vascular specimens 702, a set of constituent tissues have been identified and samples of the tissues have been plotted against a range 704 of a branch criterion. The samples may be obtained and assessed using the method 500 disclosed with reference to FIG. 5 and/or any other suitable process. Each sample is based on observed data from a single vascular specimen 702 and is assessed using the exemplary branch criterion, which may include any combination of any suitable signal parameters. As disclosed above, in the example of an IVUS imaging data set, suitable parameters include temporal and/or spectral parameters derived from 1-dimensional, 2-dimensional, or multi-dimensional data. In other exemplary imaging data sets, other suitable parameters are analyzed to determine characteristic signatures for the identified tissues. In FIG. 7, the branch criterion is expressed as a linear range, although this merely exemplary and is non-limiting.

In the illustrated embodiment, the samples fall within the ranges designated by ovals 706. As can be seen, the ranges may be discontinuous and the ranges for multiple tissues may overlap. Due to natural variation, the ranges for particular tissues may vary across specimens. For example, a branch criterion value identified by dashed line 708 falls within a range corresponding to tissue 1 in specimen 1 and specimen 2, does not correspond to any tissues in specimen 3, and falls within a range corresponding to tissue 2 in specimen 4. The modeling of block 516 of FIG. 5 attempts to determine image data parameters and branch criteria that identify unknown constituent tissues with accuracy, sensitivity, and specificity across each of the vascular specimens and in the field. This is complicated by the natural variability and the presence of statistical outliers in the reference set. Various statistical techniques known to one of skill in the art may be used in an attempt to fit signal parameters to corresponding tissues in a 1:1 fashion with perfect accuracy. However, in many embodiments, the resulting model will have a degree of uncertainty due to the heterogeneous nature of various diseased tissues. For this reason and others, embodiments of the present disclosure utilize models with multiple pattern recognition sub-models in order to manage uncertainty and improve predictive accuracy.

Referring to FIG. 8, illustrated is a flow diagram of a method 800 of building a tissue characterization model incorporating multiple parallel sub-models according to some embodiments of the present disclosure. It is understood that additional steps can be provided before, during, and after the method 800 and that some of the steps described can be replaced or eliminated for other embodiments of the method 800. The method 800 determines a set of sub-models for tissue pattern recognition by grouping samples across specimens and building an independent model for each group of samples. In some embodiments, this reduces the complexity of each individual sub-model because fewer samples are considered during the models construction. This improves runtime and reduces the need for pruning, which is used with more complicated models to manage complexity at the expense of prediction accuracy. Because the sub-models are independent, they may be traversed independently when characterizing tissue. In some embodiments, this leverages the multithreaded performance of modern processors to dramatically reduce runtime. As a further advantage, in some embodiments, multiple parallel sub-models reduce the effects of statistical outliers in the reference set of data used to construct the models.

Referring to block 802, a set of samples from a medical imaging dataset is obtained, where each sample corresponds to a constituent tissue, which may be a tissue, a tissue type, an organic or inorganic structure, and/or other suitable structure. Each sample represents a known occurrence of a particular constituent tissue and the corresponding imaging data. A set of samples may be identified for each constituent tissue. In some embodiments, the samples are obtained and the correspondence performed using tissue specimens in a method such as method 500 disclosed with reference to FIG. 5.

Referring to block 804, the samples are examined for parameters with the potential to be used as selection criteria for distinguishing constituent tissues. This process may be substantially similar to that of block 512 disclosed with reference to FIG. 5. In that regard, in various embodiments, parameters include temporal parameters and/or spectral parameters derived from 1-dimensional, 2-dimensional, or multi-dimensional data. Other suitable parameters include, but are not limited to, range (distance between the tissue and the sensor), patient demographics, medical history, and/or coexisting conditions. Parameters may be considered based on selectivity, discrimination, and other factors.

Referring to block 806, the samples are divided into groups. Typically, each group will have fewer specimens than the total number of samples making each group a subset of the total. Any of a variety of grouping schemes may be used including random, pseudo-random, weighted, and/or learning schemes. Somewhat counter-intuitively, in some embodiments, random grouping produces sub-models with predictive accuracy as good as or better than learning schemes. In embodiments utilizing weighted schemes, the grouping may affect the relative weight of each specimen during pattern recognition, and thus archetypal specimens may be included in multiple groups and in greater frequency. Conversely, more atypical or aberrational specimens may be included in fewer groups. In contrast, learning schemes begin with a core group of samples and then include further samples if they improve the accuracy and/or efficiency of the resulting characterization sub-model. Further groupings schemes are both contemplated and provided for. Use of a random, pseudo-random, or, for that matter, any other grouping scheme does not preclude the use of other classification or filtering of the samples prior to applying the grouping scheme. In an exemplary embodiment, because aspects of a backscatter response from a tissue vary according to the distance between the tissue and the sensor, samples are first grouped by range or distance from the sensor prior to applying a further grouping scheme. In further exemplary embodiments, samples are classified based on parameters such as patient demographics, medical history, coexisting conditions, and/or other suitable parameters prior to applying the grouping scheme.

Referring to block 808, a sub-model is constructed for distinguishing the constituent tissues for each group based on the samples for that particular group. The sub-model may take any of a variety of forms, including a classification tree. Accordingly, in some embodiments, the sub-models each include an independent classification tree for each group. Because the groupings each have fewer samples than the total available samples, the trees for each group may be simpler with fewer branches and greater certainty (though not necessarily greater individual accuracy) than a tree based on all available samples. Simplicity improves recognition speed and reduces the need for tree pruning, which may compromise prediction accuracy. Due to the independence, in some embodiments, the trees may be traversed independently as separate threads on a multithreaded or multi-core processor. This may further improve pattern recognition speed. As a further advantage, in some embodiments, multiple parallel trees reduce the effects of statistical outliers in the reference set of data used to construct the trees.

A system and method for performing tissue pattern recognition using multiple parallel models, such as the sub-models constructed in the method 800 of FIG. 8, are disclosed with reference to FIGS. 9 and 10. FIG. 9 is a functional block diagram of portions of the data processing system 101 of FIGS. 1 and 2, including a pattern recognition engine 900, according to some embodiments of the present disclosure. In various embodiments, the pattern recognition engine 900 receives medical imaging data and compares it against a plurality of parallel pattern recognition models to determine constituent tissues of the image. FIG. 10 is a flow diagram of a method for tissue characterization suitable for execution using the pattern recognition engine 900 according to some embodiments of the present disclosure. It is understood that additional steps can be provided before, during, and after the method 1000 and that some of the steps described can be replaced or eliminated for other embodiments of the method 1000.

The pattern recognition engine 900 includes a sensor I/O interface 902. Referring to block 1002 of FIG. 10, the sensor I/O interface 902 receives medical imaging data 901 corresponding to one or more modalities such as IVUS, FL-IVUS, IVPA imaging, OCT, computed tomography, and/or other suitable modality. In some embodiments, the sensor I/O interface 902 receives the medical imaging data 901 from a PIM (e.g., PIMs 112 and 114 of FIG. 1), although, in further embodiments, the sensor I/O interface 902 receives the medical imaging data directly from a sensing instrument (e.g., instruments 108 and 110 of FIG. 1). The sensor I/O interface 902 may perform analog-to-digital (A/D) conversion as well as amplification, filtering, time-stamping, identification, and/or aggregating of the data as part of the receiving. In baseband embodiments, medical imaging data 901 may be expressed in in-phase and quadrature (I/Q) components. Some of the pattern recognition may be performed in the I/Q domain. However, more commonly, the medical imaging data is demodulated into the RF (radio frequency) domain, and pattern recognition is performed on the demodulated medical imaging data 901. Accordingly, the sensor I/O interface 902 may include a demodulator 906 that combines in-phase and quadrature signal components. The received medical imaging data 901 is provided by the sensor I/O interface 902 to one or more classification cores 908 for use in pattern recognition as well as to the imaging engine 910 for use in constructing an image 912 of the surrounding vasculature.

Referring to block 1004 of FIG. 10, each classification core 908 receives an independent tissue characterization model (or sub-model) 904. As disclosed above, the tissue characterization models 904 may take any suitable form including that of classification trees. Accordingly, in some embodiments, the classification cores 908 each receive an independent classification tree substantially similar to those disclosed with reference to FIG. 8, where each tree is based on a different subset of samples.

Referring to block 1006 of FIG. 10, each classification core 908 applies the respective model (or sub-model) 904 to the received medical imaging data 901. In an embodiment, a classification core 908 utilizes a classification tree to determine constituent tissues from the received medical imaging data 901. The core 908 begins at a starting decision node or root node of the tree and performs the corresponding comparison upon the medical image data 904 using the parameters specified by the root node. Based on the results, the system follows the appropriate branch to a subsequent decision node or leaf node. The process continues until a leaf node is reached, at which point the corresponding constituent tissue has been identified. Because the cores 908 perform the respective pattern recognition processes independently, in some embodiments, each core 908 is an independent thread running on a multithreaded processing device. This allows the cores 908 to operate concurrently and reduces processing demands and runtime. Each core 908 process produces interim tissue identifications. Together these are distilled down to a single constituent tissue as disclosed below.

Referring to block 1008 of FIG. 10, the interim tissue identifications of the cores 908 are provided to a weighing module 914 to arbitrate between the interim results. Because each model (e.g., classification tree) is based on a different set of reference data, the results of the pattern recognition process may vary. This variation may be expressed as a difference in identified tissues and/or a difference in a metric of certainty. The weighing module 914 analyzes the disparate interim results and determines a final result in the form of a constituent tissue. In some embodiments, the weighing module 914 selects the constituent tissue identified by the majority of the pattern recognition process in what is known as a voting scheme. As each result may have an associated certainty metric, the voting scheme may consider the certainty. In some embodiments, the weighing module 914 weighs votes by their respective certainty. In some embodiments, the weighing module 914 applies a threshold and discards votes with less than a requisite amount of certainty. In some embodiments, the weighing module 914 discards the constituent tissue with the greatest number of votes if it lacks the requisite amount of certainty.

Concurrent with the tissue pattern recognition, the received medical imaging data 901 may also be used by the imaging engine 910 to construct an image 912 that visually represents the surrounding vessel. This process may include steps to remove noise and reduce distortion, steps to determine precise location from time-of-flight, steps to enhance resolution, steps to convert linear data to a polar representation, and other processing steps recognized to one of skill in the art. In some embodiments, this process also includes converting signal characteristics to luminance (brightness) or chromatic (color) values, and arranging the signals according to the spatial orientation of the corresponding scan line.

The final results of the tissue pattern recognition may be presented at a display alone or in combination with the image 912. In one typical application, referring to block 1010 of FIG. 10, a user interface module 916 of the pattern recognition engine 900 overlays the image 912 with the final results of the tissue pattern recognition to produce tissue-enhanced image 918.

FIG. 11 is a diagram of an exemplary user interface 1100 for displaying characterized tissue according to some embodiments of the present disclosure. The user interface 1100 may be displayed on a user display such as one of the displays incorporated to the bedside controller 118, main controller 120, or boom display 122 disclosed with reference to FIG. 1. The user interface 1100 represents one possible arrangement for displaying the information presented by a medical imaging system such as the medical imaging systems 100 and 200 of FIGS. 1 and 2, respectively. One skilled in the art will recognize that alternate arrangements are both contemplated and provided for.

In the illustrated embodiment, the user interface 1100 includes one or more display panes 1102 for displaying medical sensing data corresponding to one or more modalities. The user interface 1100 may also include one or more display attribute panes 1104. The display attribute pane 1104 presents user-selectable display attributes corresponding to a tissue pattern recognition process via checkboxes 1106, exclusive and non-exclusive lists 1108, radio buttons, and other suitable interface schemes. In the illustrated embodiment, the display attribute pane 1104 presents the display attribute options in categories presented as tabs 1110, although this is merely exemplary and other arrangements including dropdown menus, toolbars, trees, and other suitable arrangements are provided for. Upon user selection of display attribute, the display attribute is applied to the corresponding data and the display is updated. This may include updating a tissue marker (e.g., marker 1112).

The tissue marker 1112 represents an identified constituent tissue such as that identified by the method 1000 of FIG. 10. In that regard, the tissue marker 1112 displays the spatial location of the constituent tissue relative to the image produced by the medical sensing data. This allows operators to quickly and accurately assess vascular structures for diagnostic purposes, to monitor treatments, to navigate vascular passages, and for other observational and interventional purposes. For clarity, the tissue marker 1112 may take the form of an outline, a highlight, a label, and/or other suitable annotation, and any number of tissue markers 1112 may be displayed at any one time.

Although illustrative embodiments have been shown and described, a wide range of modification, change, and substitution is contemplated in the foregoing disclosure and in some instances, some features of the present disclosure may be employed without a corresponding use of the other features. Further, as described above, the components and extensions described above in association with the multi-modality processing system may be implemented in hardware, software, or a combination of both. The processing systems may be designed to work on any specific architecture. For example, the systems may be executed on a single computer, local area networks, client-server networks, wide area networks, internets, hand-held and other portable and wireless devices and networks. It is understood that such variations may be made in the foregoing without departing from the scope of the present disclosure. Accordingly, it is appropriate that the appended claims be construed broadly and in a manner consistent with the scope of the present disclosure.

What is claimed is:

1. A method for analyzing medical imaging data, the method comprising:
receiving a set of medical imaging data;
receiving a set of independent tissue characterization models;
applying each model of the set of independent tissue characterization models to the set of medical imaging data to obtain a plurality of interim classification results; and
performing an arbitration of the plurality of interim classification results to determine a constituent tissue for the set of medical imaging data.

2. The method of claim 1, wherein each model of the set of independent tissue characterization models is applied to the set of medical imaging data concurrently.

3. The method of claim 1, wherein each model of the set of independent tissue characterization models is applied to the set of medical imaging data in parallel.

4. The method of claim 1, wherein each model of the set of independent tissue characterization models is applied to the set of medical imaging data as a separate thread.

5. The method of claim 1, wherein the performing of the arbitration includes applying a voting scheme to the plurality of interim classification results to determine the constituent tissue.

6. The method of claim 5, wherein the voting scheme weighs votes based on a certainty associated with each of the plurality of interim classification results.

7. The method of claim 1 further comprising displaying the determined constituent tissue in combination with a graphical representation of the set of medical imaging data.

8. The method of claim 7, wherein the displaying of the constituent tissue includes overlaying the graphical representation with a tissue marker corresponding to the constituent tissue.

9. A medical data processing system comprising:
a sensor I/O interface operable to receive imaging data from an imaging instrument;
a plurality of classification cores each operable to receive an independent characterization model and to apply the respective independent characterization model to the received imaging data to produce an interim tissue identification; and
a weighing module operable to receive the interim tissue identification from each of the plurality of classification cores and to determine a constituent tissue from the interim tissue identifications based on an arbitration scheme.

10. The system of claim 9, wherein the plurality of classification cores are further operable to apply the respective independent characterization model to the received imaging data concurrently.

11. The system of claim 9, wherein the plurality of classification cores are further operable to apply the respective independent characterization model to the received imaging data in parallel.

12. The system of claim 9, wherein the received independent characterization models each include a classification tree, and wherein each of the plurality of classification cores are further operable to traverse the respective classification tree to produce the interim tissue identification.

13. The system of claim 9, wherein the weighing module is further operable to apply a voting scheme to the interim tissue identifications to determine the constituent tissue.

14. The system of claim 13, wherein the voting scheme weighs votes based on a certainty associated with each of the interim tissue identifications.

15. The system of claim 9 further comprising an imaging engine operable to construct a visual representation of vasculature based on the received imaging data.

16. The system of claim 15 further comprising a user interface module operable to display the determined constituent tissue in combination with the visual representation.

17. A method for constructing a tissue characterization model, the method comprising:
receiving imaging data samples;
correlating the imaging data samples to observed histology to determine a constituent tissue for each of the imaging data samples;
grouping the imaging data samples into a plurality of groups; and
constructing a tissue characterization sub-model for each group of the plurality of groups based on imaging data samples grouped into the respective group,
wherein each of the tissue characterization sub-models is independently operable to characterize an unknown imaging data sample.

18. The method of claim 17, wherein each of the sub-models includes a classification tree.

19. The method of claim 17, wherein the grouping of the imaging data samples utilizes a random grouping scheme.

20. The method of claim 17 further comprising determining a parameter of the imaging data samples to use as a selection criteria.

21. The method of claim 20, wherein each of the sub-models is further operable to classify the unknown imaging data sample using the determined parameter.

22. The method of claim 21, wherein the parameter includes one of a temporal parameter and a spectral parameter.

23. The method of claim 22, wherein the one of the temporal parameter and the spectral parameter is derived from data corresponding to at least two dimensions.

24. The method of claim 21, wherein the parameter includes one of a patient demographic, a medical history, and a coexisting condition.
